(19) United States
(12) Patent Application Publication
(10) Pub. No.: US 2013/0215081 A1
(43) Pub. Date: Aug. 22, 2013

(54) METHOD OF ILLUMINATING SEMI TRANSPARENT AND TRANSPARENT INPUT DEVICE AND A DEVICE HAVING A BACK ILLUMINATED MAN MACHINE INTERFACE

(71) Applicants: Dror Levin, Moshav Sde Yaacov (IL); Jacob Eichbaum, Holon (IL); Shahar Amit, Tel-Aviv (IL); Yakir Damti, Moshav Ahihud (IL)

(72) Inventors: Dror Levin, Moshav Sde Yaacov (IL); Jacob Eichbaum, Holon (IL); Shahar Amit, Tel-Aviv (IL); Yakir Damti, Moshav Ahihud (IL)

(73) Assignee: Grippity Ltd., Holon, IL (US)

(21) Appl. No.: 13/882,764

(22) PCT Filed: Nov. 3, 2011
(86) PCT No.: PCT/IL11/50004

§ 371 Date: May 1, 2013

Related U.S. Application Data
(60) Provisional application No. 61/410,001, filed on Nov. 4, 2010.

(51) Int. Cl. G06F 1/16; G06F 3/041

(52) U.S. Cl. CPC G06F 1/16; G06F 3/041
USPC 345/174; 345/173

(57) ABSTRACT

A handheld input device that comprises a touchpad having at least partly transparent panel with front and back sides which respectively face a front space and a back space, front and back touch sensing surfaces formed respectively at the front and back sides to detect a plurality of front touch events and a plurality of back touch events respectively on the front and back sides, and at least one back illumination source, mounted in the handheld device to illuminate fingertips facing the back touch sensing surface at the back space.

### FIELD AND BACKGROUND OF THE INVENTION

The present invention, in some embodiments thereof, relates to man machine interfaces and, more particularly, but not exclusively, to a method of illuminating semi transparent and transparent man machine interface and a device having a back illuminated man machine interface.

The field of man machine interfaces for hand-held devices which function as input and/or control devices is a particularly dynamic one, with devices of all shapes, sizes and functionalities being developed and available to the user. Each purports to offer some advantage in terms of utility, mobility, ease of use, pleasing appearance or other attractive feature or combination of features.

Some of the latest developments relate to transparent or semi transparent touchpads, array of keys mounted on a surface and/or touch screens, referred to herein, for brevity, see-through touchpads. Devices which use such see-through touch screens are convenient for holding by the one or more hands of the user, with the thumbs above one side of the see-through touch screen and the bottom fingertips underlying the opposing side.

For example, U.S. Pat. No. 6,885,314, filed on Aug. 16, 2001, describes a hand-held input/control device designed and configured such that, when it is held by a user oriented with its operating surface facing away from the user, the user may view the operation of the manually operable control members deployed on that operating surface.

Another development is described in U.S. Patent Application No. 2010/0188353 which describes a terminal device having a dual touch screen capable of controlling a content. The terminal device displays content using a display module 104 and includes a processor coupled to the terminal to check content mapped to an area at which a touch event is detected and released from the dual touch screen including a first touch sensor and a second touch sensor and to control the content according to the touch event.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### SUMMARY OF THE INVENTION

According to some embodiments of the present invention, there is provided a handheld input device. The handheld input device comprises a touchpad which comprises at least partly transparent panel having front and back sides which respectively face a front space and a back space, front and back touch sensing surfaces formed respectively at the front and back sides to detect a plurality of front touch events and a plurality of back touch events respectively on the front and back sides, and at least one back illumination source, mounted in the handheld device to illuminate fingertips facing the back touch sensing surface at the back space.

Optionally, the panel is a display unit set to display content.

More optionally, the at least one back illumination source are spread in the at least partly transparent panel so as to illuminate the back space without illuminating the display unit directly.

Optionally, the front and back touch sensing surfaces are front and back sides of at least one dual side touch sensor.

More optionally, the at least one dual side touch sensor comprises at least capacitive sensor having opposing touch sensitive surfaces.

More optionally, the at least one dual side touch sensor comprises at least resistive sensor having opposing touch sensitive surfaces.

Optionally, the at least one back illumination source comprises a plurality of light emitting diodes (LEDs).

More optionally, each the LED being angled in an angle of between 20 and 50 degrees in relation to an axis perpendicular to the back side.

Optionally, the handheld input device comprises at least partly opaque fixture that limits the propagation of light from the at least one back illumination source in the panel.

Optionally, the handheld input device comprises a housing that confines the touchpad and sized and shaped in a manner that it is convenient to holding it by one or two hands of the user, with the thumbs above the sensing surface and the fingertips of other fingers underlying the back touch sensing surface.

Optionally, each one of the front and back touch sensing surfaces comprises a member of a group consisting of a resistive touch screen panel, a capacitive touch screen panel, a projected capacitive touch (PCT) technology panel, and an arrangement of mutual capacitive sensors.

Optionally, at least one of the front and back touch sensing surfaces comprises an at least partly transparent push button.

More optionally, the handheld input device comprises a display module for rendering on the display unit a finger operated man machine facing the front space; wherein the plurality of back touch events are translated to a plurality of user inputs indicative of at least one of a plurality of characters, a plurality of cursor maneuvering instructions, and a plurality of object maneuvering instructions, according to a relative location thereof in relation to the rendered finger operated man machine.

Optionally, the handheld input device comprises a plurality of light deflecting elements for deflecting light from the at least one back illumination source toward the fingertips at the back space.

Optionally, the plurality of deflecting elements are distributed in the panel.

Optionally, the plurality of deflecting elements are distributed on the panel.

Optionally, the handheld input device comprises a layer of luminescence materials mounted on top of the back side.

Optionally, the handheld input device comprises a semi reflective layer mounted on top of the front side and set to reflect at least some of the light emanated from the panel toward the back space.

Optionally, the at least one back illumination source emits ultraviolet light.

Optionally, the at least one back illumination source emits infrared light.

More optionally, the handheld input device comprises a layer of switchable glass mounted on top of the back side and operated according to at least one of the displayed in the display unit and a user selection.

More optionally, the layer of switchable glass changes light transmission properties thereof when a voltage in a certain range is applied thereon.

More optionally, the handheld input device further comprises an electro luminance (EL) film mounted on top of the back side and operated according to at least one of the displayed in the display unit and a user selection.

Optionally, the handheld input device further comprises at least one front illumination source, mounted in the handheld device to illuminate fingertips facing the front touch sensing surface at the front space, a motion sensor which detects an orientation of the handheld input device, and a computing unit which switches between the at least one front illumination source and the at least one back illumination source according to the orientation.

According to some embodiments of the present invention, there is provided a method of operating a handheld input device. The method comprises displaying a finger operated man machine interface on at least partly transparent display unit of a handheld device, the display unit having front and back sides which respectively face a front space and a back space to display content, detecting a plurality of back touch events made by fingertips maneuvered facing the back touch sensing surface in the back space, and illuminating, during the detection, the fingertips at least one illumination source mounted in the handheld device.

According to some embodiments of the present invention, there is provided a handheld input device which comprises a touchpad comprising at least partly transparent panel having front and back sides which respectively face a front space and a back space, front and back touch sensing surfaces formed respectively at the front and back sides to detect a plurality of front touch events and a plurality of back touch events respectively on the front and back sides, and a semi reflective layer mounted on top of the front side and set to reflect at least some of the light emanated from the panel to illuminate fingertips facing the back touch sensing surface at the back space.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are a schematic illustration of a handheld device having a semi transparent or transparent touchpad and an exemplary cross section of this handheld device, according to some embodiments of the present invention;

FIGS. 2A and 2B are a schematic illustration of another handheld device and an exemplary cross section thereof, according to some embodiments of the present invention;

FIG. 2C depicts device having back illumination sources in a set of undersurface, according to some embodiments of the present invention; and

FIGS. 3A and 3B are a schematic illustration of another handheld device and an exemplary cross section thereof the handheld device, according to some embodiments of the present invention.

### DESCRIPTION OF EMBODIMENTS OF THE INVENTION

The present invention, in some embodiments thereof, relates to man machine interfaces and, more particularly, but not exclusively, to a method of illuminating semi transparent and transparent man machine interface and a device having a back illuminated man machine interface.

According to some embodiments of the present invention there are provided devices having a see-through touchpad and one or more back illumination sources for illuminating the area behind the see-through touchpad. These devices are optionally sized and shaped in a manner that is convenient for a user to hold them with one or more hands, with the thumbs above one uppersurface of the see-through touch screen and the fingertips of the other fingers underlying the opposing undersurface. The back illumination sources are set to illuminate the fingertips underlying below or behind the opposing undersurface. Optionally, the see-through touchpad is a transparent touch screen with two opposing surfaces which are reactive to touch events, such as taps. In such a manner the bottom fingertips input data by tapping on the undersurface and the thumbs are used for inputting data by tapping on the uppersurface.

Optionally, the illumination source are integrated into a housing of the device and set, for example angled, to illuminate the fingertips of the user in the area beneath the undersurface. Optionally, the illumination sources are integrated into see-through touchpad. Optionally, one or more light deflecting elements are attached to the undersurface so as to increase the illumination of the bottom fingertips.

Optionally, one or more coatings and/or layers of semi reflective materials or elements are added on top of the uppersurface. These coatings and/or layers reflect some of the light emitted by the see-through touchpad towards the area beneath or behind the undersurface.

Optionally, one or more coatings and/or layers of luminescence materials, such as phosphoric and/or fluorescent materials, are added on top of the undersurface. These coatings and/or layers reflect some of the light from the see-through touchpad toward and through the uppersurface.

Optionally, the device further comprises one or more finger proximity detectors for detecting the proximity of the fingertips to the see-through touchpad. Optionally, the illumination sources are activated and/or operated according to the outputs of the finger proximity detectors.

According to some embodiments of the present invention there is provided a see-through touchpad having an organic light-emitting diode (OLED) touch screen. In such an embodiment, the brightness of the OLED touch screen and/or of areas thereof is effected by the outputs of finger proximity detectors, as outlined above and described below, inputs made by the bottom fingers, and/or modes selected for inputs made by the bottom fingers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

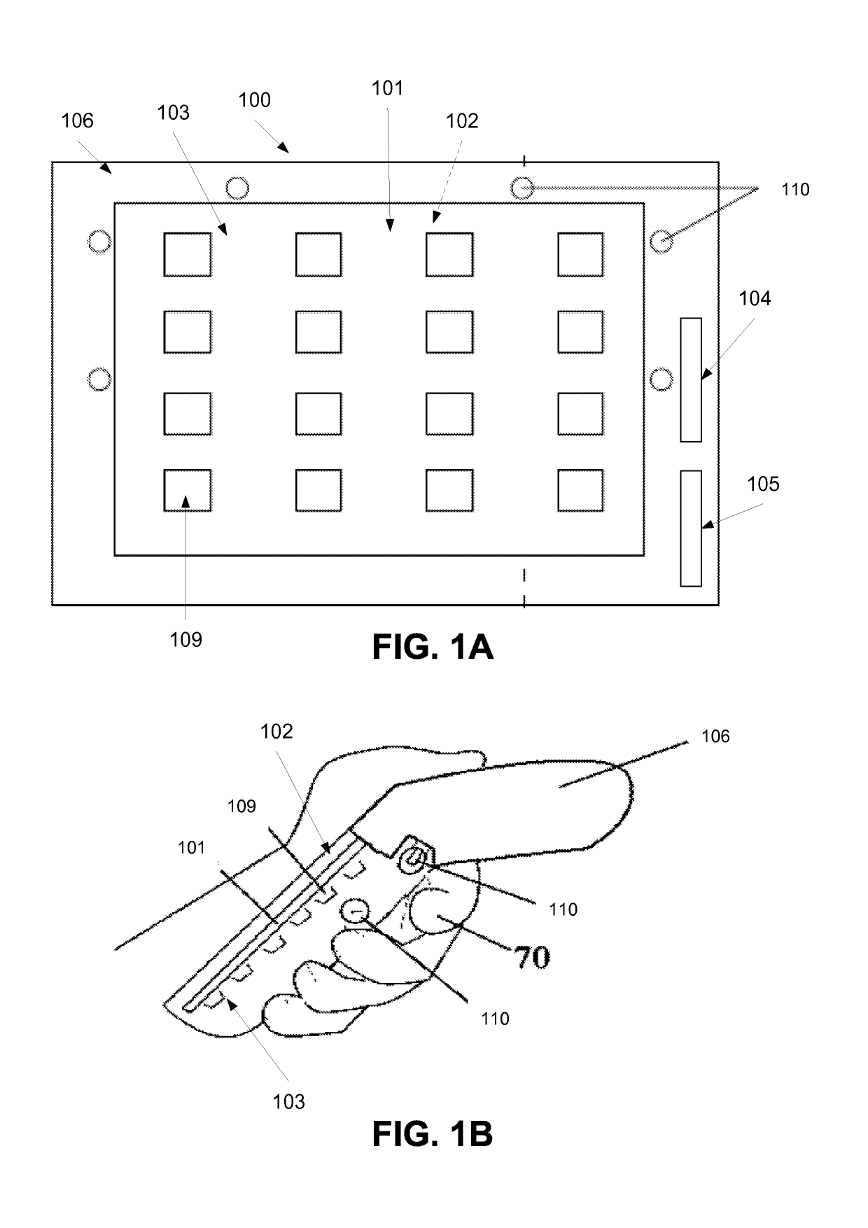

Reference is now made to FIGS. 1A and 1B, which are, respectively, a schematic illustration of a handheld device 100 having a semi transparent or transparent touchpad 101, also referred to as a panel, which may be referred to herein as a touchpad with at least partly transparent display unit, and an exemplary cross section of the handheld device 100, according to some embodiments of the present invention. The handheld device 100 includes one or more back illumination sources 110 for illuminating fingertips which are placed, in use, behind the touchpad 101, according to some embodiments of the present invention. For brevity, these fingertips are referred to herein as bottom fingertips. The semi transparent or transparent touchpad 101 has an undersurface 102 and an uppersurface 103, also referred to as front and back touch sensing surfaces, which are optionally separately adapted to detect the presence and the location of a touch of a fingertip thereon. The front and back touch sensing surfaces may be separate units. The front and back touch sensing surfaces may be implemented using one or more dual side touch sensors, for example an array of capacitive sensors having opposing touch sensitive surfaces and/or an array of resistive sensors having opposing touch sensitive surfaces. This touchpad 101 may be referred to herein as a see-through touchpad 101. Each one of the undersurface 102 and the uppersurface 103, which are the opposing surfaces of the see-through touchpad 101, comprises one or more touch sensors such as a resistive touch screen panel, a capacitive touch screen panel, projected capacitive touch (PCT) technology panel, one or more mutual capacitive sensors, one or more Self capacitance sensors, and/or any other sensors which are adapted to detect touch events of fingers. The undersurface 102 and the uppersurface 103 may include other keys, such as push-buttons which are mounted on top of them. In such an embodiment, the push-buttons are optionally semi transparent or transparent so as to allow the user to see therethrough. Optionally, the see-through touchpad 101 includes and/or displays a number of input controls, such as buttons. Optionally, the handheld device 100 further comprises a display module 104 for rendering the input controls 109 on the see-through touchpad 101. The input controls may be any finger operated man machine interface, such as keys of a keyboard, a virtual maneuver control, such as a virtual joystick, a pointer, such as a cursor, a link, an image, a symbol, a character and/or the like. The handheld device 100 further comprises a computing unit 105, such as a microprocessor or a central processing unit (CPU) coupled to the device 100 and is configured to receive the outputs of the touch sensors of the undersurface 102 and the uppersurface 103 which are indicative of touch events. The computing unit 105 outputs control instructions according to the received outputs, for example to the display module 104 and/or to one or more applications or modules of the handheld device 100.

According to some embodiments of the present invention, the undersurface 102 may function as an uppersurface 103 and vice versa. In such an embodiment, the user may hold device with any of its wide sides of the see-through touchpad 101 positioned to face his eyes and optionally adjust the direction the back illumination sources faces, for example as described below.

Optionally, the device 100 comprises a transparent or a semi transparent housing 106 which supports the aforementioned components 101-105. The housing is optionally a frame shaped structure that confines the see through touch screen 101. Optionally, the housing holds the computing unit 105 and the display module 104 therein. It should be noted that though the housing 106 depicted in FIG. 1B is angled, any other housing may be used, for example a linear frame shaped housing that confines the through touch screen 101. Optionally, the housing is identical from opposing sides, allowing the undersurface 102 to function as an uppersurface 103 and vice versa without changing the usage experience.

Optionally, the housing of the handheld device 100 is sized and shaped in a manner that it is convenient to hold it by one or two hands of the user, with the thumbs above the uppersurface 103 and the bottom fingertips underlying the undersurface 102. In such a manner, the thumbs may be used to input data on the uppersurface 103 and the bottom fingertips are used to input data on the undersurface 102. The bottom fingertips and the thumbs may be used to input data simultaneously, for example as a multi touch event and/or sequentially, for example one at the time, and/or interchangeably, for example pressing on the same control which is depicted on the see-through touchpad 101 from opposing sides. Optionally, only the undersurface 102 is reactive to touch events. In use, the bottom fingertips are visible through the see-through touchpad 101, allowing the user to see them and to direct them toward touch locations on the undersurface 102, for example in front of virtual controls which are displayed on the see-through touchpad 101 from a point of view facing the undersurface 102.

The device 100 further comprises one or more back illumination sources 110 for illuminating the bottom fingertips which are placed beneath the undersurface 102. In such an embodiment, the back illumination sources 110, which may be light emitting diodes (LEDs), are directed toward the space below or behind the undersurface 102. In such a manner, when the device 100 is held in a manner that the uppersurface 103 faces the user, the shadow casted by the touch screen 101 on the bottom fingertips is reduced or eliminated and/or the visibility of the bottom fingertips is increased, especially in lowlight surroundings. In FIG. 1, the back illumination sources 110 are integrated into the housing 106. The housing blocks light from the back illumination sources 110 from affecting the display of the see-through touchpad 101. Optionally, the back illumination sources 110 are angled toward the space below or behind the see-through touchpad 101. For example, the back illumination sources 110 are LEDs which are angled in an angle of between 20 and 50 degrees in relation to an axis perpendicular to the back illumination sources 110.

Optionally, the device 100 further comprises one or more front illumination sources 110 for illuminating the bottom fingertips which are placed beneath the uppersurface 103 when the see-through touchpad 101 is overturned. In such an embodiment both the undersurface 102 and the uppersurface 103 may face the user while being used for detecting touch events from bottom fingers. Optionally, a motion sensor such as an accelerometer and a gyroscope is used to identify which surface is on top and forwards it to a computing unit, for example the computing unit of the handheld device which instructs flipping the display and the switching between activating the front illumination sources and the back illumination sources to illuminate the bottom fingertips accordingly, and/or change the content projected on the display.

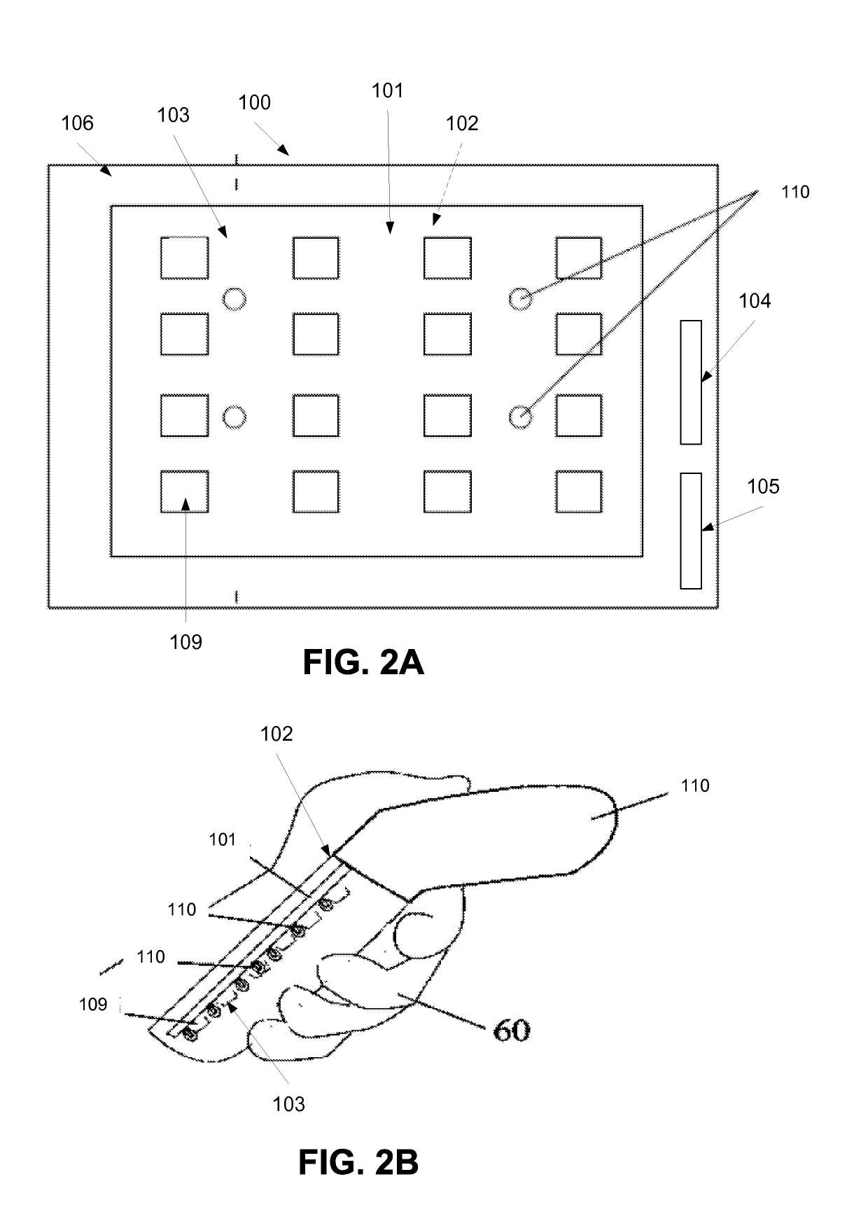

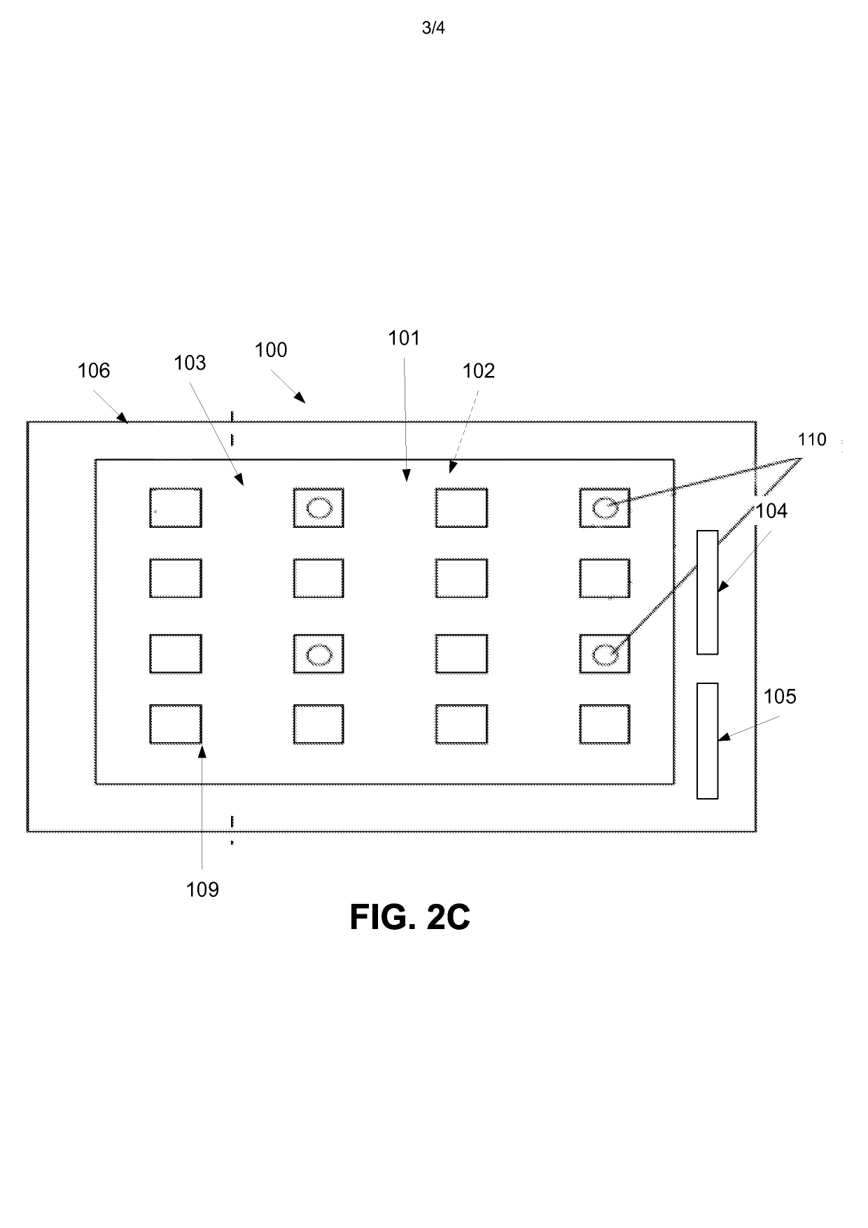

Reference is now made to FIGS. 2A and 2B which are, respectively, another schematic illustration of another handheld device 200 and an exemplary cross section of the handheld device 200, according to some embodiments of the present invention. The components are as described above with regard to FIG. 1 except that in the embodiments depicted in FIGS. 2A and 2B the back illumination sources are illumination sources 210 which are integrated into the see-through touchpad 101. Optionally, the lateral sides of each back illumination source 110 are covered by a fixture that limits the light propagation in the transparent medium of the see-through touchpad 101. For example, the fixture is a tubular lightshade made of an opaque or semi opaque material, for example a layer of paint in which light is strongly scattered, a carbon-filled polymer, a metal foil and the like. In such a manner, the affect of direct illuminating light from the back illumination sources 110 on the display of the see-through touchpad 101, for example on its brightness, is reduced or eliminated. In FIG. 2B as in FIG. 1B, the housing 106 of the device 100 supports only the upper side of the see-through touchpad 101, in an angle which is adjusted to a hand grip. The user's thumb is holding the device 100 in the upper side of the housing 106. The bottom fingertips, marked herein with 60, are pressing a set of undersurface buttons which are mounted on the undersurface 102, such as 109. The see-through touchpad 101 and optionally the set of virtual and/or physical undersurface buttons 109 cast shadow on the fingers 60. The integrated illumination sources 110 are spread between the set of undersurface buttons for illuminating the bottom fingertips 60 in a substantially equal manner. For example, the integrated illumination sources 110 are spread in the touchpad 101 so that fingerprints in front of any segment thereof are illuminated without illuminating display unit.

According to some embodiments of the present invention, the back illumination sources 110 are placed in one or more members of the set of undersurface buttons 109, for example as shown at FIG. 2C. The set of undersurface buttons 109 are embedded or mounted on the undersurface 102. The undersurface buttons 109 optionally indicate to the user when they are pressed, for example by visual signaling of light from the back illumination sources 110. In such a manner, the back illumination sources 110 are used for illuminating the bottom fingertips and for visual feedback, optionally simultaneously.

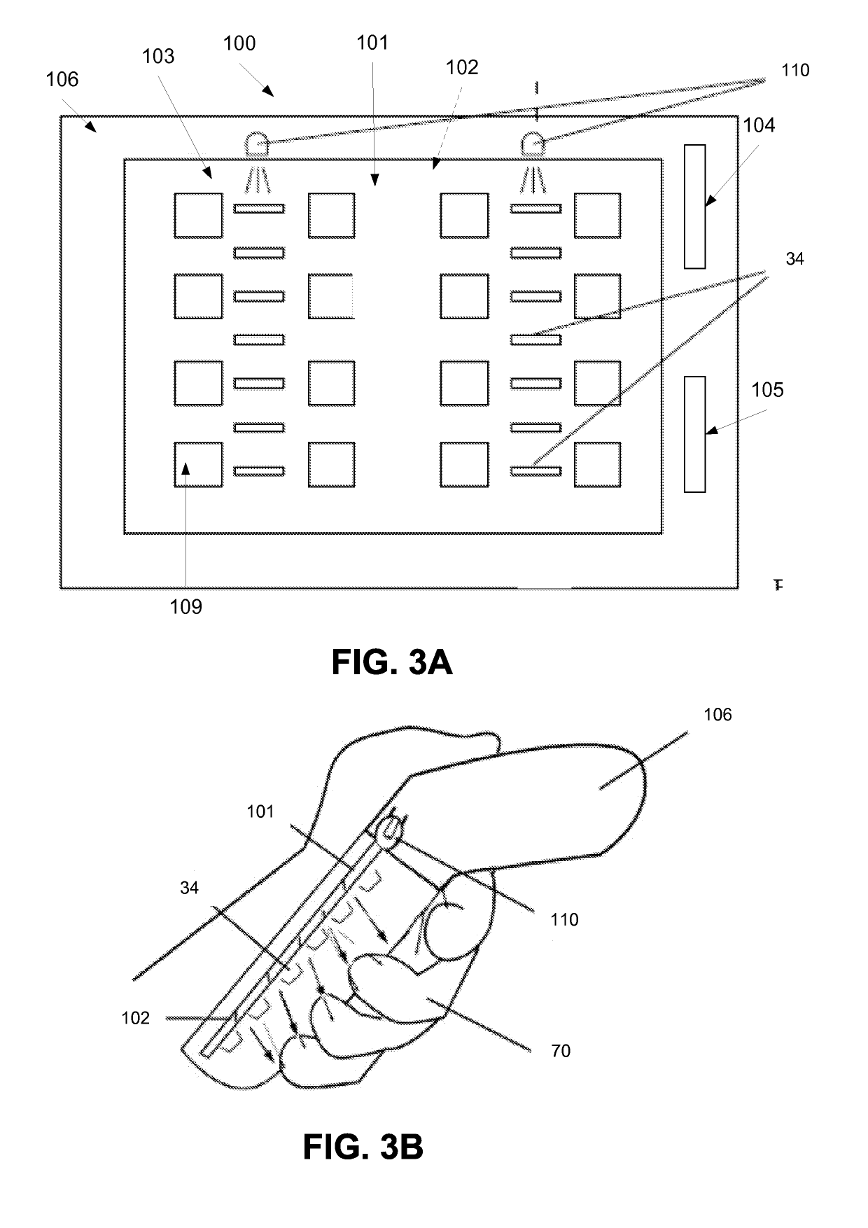

Reference is now made to FIGS. 3A and 3B which are, respectively, a schematic illustration of another handheld device 300 and an exemplary cross section of the handheld device 300, according to some embodiments of the present invention. The components are as described above with regard to FIG. 1 except that in the embodiments depicted in FIGS. 3A and 3B the back illumination sources 110 are mounted on the backside of the housing 106 and directed toward the space behind the undersurface 102 from its lateral perimeters where the center of illumination is optionally parallel to the see-through touchpad 101.

Optionally, the light projected by the back illumination sources 110 is propagated toward and via an array of light deflecting elements 34, such as transparent or semi transparent slender members made of one or more transparent polymers such as polycarbonate, polyvinyl butyral, and/or acrylic polymer. The deflecting elements 34 are attached and/or part of the undersurface 102. As depicted in FIG. 3B, the back illumination sources 110 may be distributed along different faces of the device, pointing towards the fingers, marked herein as 70.

The back illumination sources 110, in all the above mentioned embodiments, increase the visibility of the bottom fingertips in relation to the keys and/or the display on the see-through touchpad 101, at any light condition. Furthermore, in dark conditions, though the housing doesn't cast shadow on the fingers, the back illumination sources 110 illuminates the fingers, thus allowing the user to see his fingers in the dark. Furthermore, the illumination of the bottom fingertips reduces the reflection of bright objects that appear on the display of the see-through touchpad 101.

According to some embodiments of the present invention, the device further includes one or more finger proximity detectors, such as capacitive detectors, inductive detectors, infrared (IR) detectors or acoustic proximity detectors. The finger proximity detector identifies when the finger tips are close to the undersurface 102 and output an indication to the computing unit 105 or to a controller that is connected to the back illumination sources 110. The computing unit 105 or the controller operates the back illumination sources 110 accordingly, for example activates, dims, or intensifies the back illumination sources 110. Optionally, the finger proximity detectors are arranged so as to detect which regions of the undersurface 102 are close to the bottom fingertips. In such a manner, only part of the back illumination sources 110 may be operate to illuminate only some of the space below or behind the undersurface 102. This allows saving energy and increasing the battery life of the device 100.

According to some embodiments of the present invention, the see-through touchpad 101 is an OLED touch screen that emits light when an electric current passes therethrough. Optionally, the brightness of the OLED touch screen is controlled according to the proximity of the fingers to the undersurface 102, for example according to the outputs of the finger proximity detectors. Optionally, the brightness of only some regions of the OLED touch screen is changed so as to illuminate only the fingertips which are placed in proximity to the see-through touchpad 101. Such an illumination may be operated according to the regions identified by the one or more finger proximity detectors. Additionally or alternatively, the brightness of the OLED touch screen may be controlled according to the regions which are pressed by the bottom fingertips of the user. For example, when a touch event is detected in a certain area of the OLED screen, for example the detection of a tap, the brightness around this area is intensified, illuminating the bottom fingertips therearound and facilitating the continuation of the data input and/or control. Optionally, portions of the OLED screen are allocated for illuminating the space behind the undersurface 102. For example, a frame of OLED pixels around a display on the see-through touchpad 101 and/or intertwining strips in this display. Optionally, the brightness of the OLED touch screen is adjusted according to the operation mode of the device 100. When the device 100 is a data input mode, the brightness is increased so as to illuminate the bottom fingertips. However, when the device 100 is in a play or display mode the brightness is not changed.

According to some embodiments of the present invention, a semi reflective layer, for example coating or a laminated layer, such as a polarizing layer and/or coating and/or an array of diffractive elements, is added on top of the uppersurface 103, reflecting some of the light which is directed toward the face of the user to the opposite direction, namely toward the bottom fingertips. In such an embodiment, illumination light source may or may not be used. Optionally, the semi reflective layer is added to a see-through touchpad 101 that includes an OLED touch screen. In such a manner, the illumination of the bottom fingertips is illuminated or intensified when illumination light source(s) are used. Optionally, the semi reflective layer is an integral part of the see-through touchpad 101. Optionally, the semi reflective layer and/or coating and/or the array includes one or more air bubbles formed in the see-through touchpad 101, one or more metallic parts placed in the see-through touchpad 101, and/or the like.

According to some embodiments of the present invention, the undersurface 102 is coated, laminated and/or layered with luminescence materials, such as phosphoric and/or fluorescent materials. The layer or coating of luminescence materials is used for both reflecting light from the illumination sources 110 toward and through the uppersurface 103 and for illuminate the space therebelow or behind. The transparency of the layer or coating of luminescence materials is a derivative of its thickness. Additionally or alternatively, the illumination sources 110 are ultraviolet (UV) emitting sources, such as UV emitting LEDs and/or infrared (IR) emitting sources, such as IR emitting LEDs.

According to some embodiments of the present invention, an opaque transparent layer is attached behind the undersurface 102. The opaque transparent layer is set to allow the passage of light when the user inputs data using the see-through touchpad 101 and to block light when the user uses the see-through touchpad 101 to watch content, such as text, video, and/or images. The opaque transparent layer is optionally EGlass or switchable glass which is an electrically switchable glass or glazing which changes light transmission properties when voltage is applied or electro luminance (EL) film that emit light and turns opaque or semi transparent when voltage is applied. For example, the opaque transparent layer includes an electrochromic device, a suspended particle device, a polymer dispersed liquid crystal device, and/or a micro-blinds layers. The opaque transparent layer is optionally a transparent liquid crystal display (LCD) which is set to display a dark background, optionally black, behind the see-through touchpad 101 in an opaque mode and to be inactive in a transparent mode. The opaque transparent layer is optionally controlled by a managing module that operates it in correspondence with the presentation of input buttons and/or GUIs on the see-through touchpad 101.

It is expected that during the life of a patent maturing from this application many relevant system and methods will be developed and the scope of the term computing unit, display unit, touch screen, sensor , detector, and polarizing layer and/or coating is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A handheld input device, comprising:
a touchpad which comprises at least partly transparent panel having front and back sides which respectively face a front space and a back space;
front and back touch sensing surfaces formed respectively at said front and back sides to detect a plurality of front touch events and a plurality of back touch events respectively on said front and back sides; and
at least one back illumination source, mounted in said handheld device to illuminate fingertips facing said back touch sensing surface at said back space.

2. The handheld input device of claim 1, wherein said panel is a display unit set to display content.

3. The handheld input device of claim 2, wherein said at least one back illumination source are spread in said at least partly transparent panel so as to illuminate said back space without illuminating said display unit directly.

4. The handheld input device of claim 1, wherein said front and back touch sensing surfaces are front and back sides of at least one dual side touch sensor.

5. The handheld input device of claim 4, wherein said at least one dual side touch sensor comprises at least capacitive sensor having opposing touch sensitive surfaces.

6. The handheld input device of claim 4, wherein said at least one dual side touch sensor comprises at least resistive sensor having opposing touch sensitive surfaces.

7. The handheld input device of claim 1, wherein said at least one back illumination source comprises a plurality of light emitting diodes (LEDs).

8. The handheld input device of claim 7, wherein each said LED being angled in an angle of between 20 and 50 degrees in relation to an axis perpendicular to said back side.

9. The handheld input device of claim 1, further comprising at least partly opaque fixture that limits the propagation of light from said at least one back illumination source in said panel.

10. The handheld input device of claim 1, further comprising a housing that confines said touchpad and sized and shaped in a manner that it is convenient to holding it by one or two hands of the user, with the thumbs above said sensing surface and the fingertips of other fingers underlying said back touch sensing surface.

11. The handheld input device of claim 1, wherein each one of said front and back touch sensing surfaces comprises a member of a group consisting of a resistive touch screen panel, a capacitive touch screen panel, a projected capacitive touch (PCT) technology panel, and an arrangement of mutual capacitive sensors.

12. The handheld input device of claim 1, wherein at least one of said front and back touch sensing surfaces comprises an at least partly transparent push button.

13. The handheld input device of claim 2, further comprising a display module for rendering on said display unit a finger operated man machine facing said front space; wherein said plurality of back touch events are translated to a plurality of user inputs indicative of at least one of a plurality of characters, a plurality of cursor maneuvering instructions, and a plurality of object maneuvering instructions, according to a relative location thereof in relation to said rendered finger operated man machine.

14. The handheld input device of claim 1, further comprising a plurality of light deflecting elements for deflecting light from said at least one back illumination source toward said fingertips at said back space.

15. The handheld input device of claim 14, wherein said plurality of deflecting elements are distributed in said panel.

16. The handheld input device of claim 14, wherein said plurality of deflecting elements are distributed on said panel.

17. The handheld input device of claim 1, further comprising a layer of luminescence materials mounted on top of said back side.

18. The handheld input device of claim 1, further comprising a semi reflective layer mounted on top of said front side and set to reflect at least some of the light emanated from said panel toward said back space.

19. The handheld input device of claim 1, wherein said at least one back illumination source emits ultraviolet light.

20. The handheld input device of claim 1, wherein said at least one back illumination source emits infrared light.

21. The handheld input device of claim 2, further comprising a layer of switchable glass mounted on top of said back side and operated according to at least one of the displayed in said display unit and a user selection.

22. The handheld input device of claim 21, wherein said layer of switchable glass changes light transmission properties thereof when a voltage in a certain range is applied thereon.

23. The handheld input device of claim 2 further comprising an electro luminance (EL) film mounted on top of said back side and operated according to at least one of the displayed in said display unit and a user selection.

24. The handheld input device of claim 1, further comprising:
at least one front illumination source, mounted in said handheld device to illuminate fingertips facing said front touch sensing surface at said front space,
a motion sensor which detects an orientation of said handheld input device, and
a computing unit which switches between said at least one front illumination source and said at least one back illumination source according to said orientation.

25. A method of operating a handheld input device, comprising:
displaying a finger operated man machine interface on at least partly transparent display unit of a handheld device, said display unit having front and back sides which respectively face a front space and a back space to display content;
detecting a plurality of back touch events made by fingertips maneuvered facing said back touch sensing surface in said back space; and
illuminating, during said detection, said fingertips at least one illumination source mounted in said handheld device.

26. A handheld input device, comprising:
a touchpad comprising at least partly transparent panel having front and back sides which respectively face a front space and a back space;
front and back touch sensing surfaces formed respectively at said front and back sides to detect a plurality of front touch events and a plurality of back touch events respectively on said front and back sides; and
a semi reflective layer mounted on top of said front side and set to reflect at least some of the light emanated from said panel to illuminate fingertips facing said back touch sensing surface at said back space.
